(19) United States
(12) Patent Application Publication
(10) Pub. No.: US 2025/0131279 A1
(43) Pub. Date: Apr. 24, 2025

(54) TRAINING NEURAL NETWORKS FOR POLICY ADAPTATION

(71) Applicant: InstaDeep Ltd, London (GB)

(72) Inventors: Thomas Daniel BARRETT, Oxford (GB); Felix Maxime CHALUMEAU, Cape Town (ZA); Shikha SURANA, London (GB); Nathan Paul GRINSZTAJN, London (GB); Clement Valentin BONNET, Paris (FR); Arnu PRETORIUS, Cape Town (ZA); Alexandre Nathalie R. LATERRE, London (GB)

(21) Appl. No.: 18/772,900

(22) Filed: Jul. 15, 2024

Related U.S. Application Data
(60) Provisional application No. 63/592,408, filed on Oct. 23, 2023.

(51) Int. Cl. G06N 3/092

(52) U.S. Cl. CPC G06N 3/092

(57) ABSTRACT

Systems, storage mediums comprising instructions, and methods of training a neural network to determine solutions to an optimization problem are provided. The methods involve obtaining training data representing a plurality of instances of an optimization problem, each instance being represented by a set of state parameters. For each instance of the optimization problem, a plurality of solutions are generated, each solution being generated using a neural network conditioned on an N-dimensional vector. Training the neural network conditioned on an N-dimensional vector associated with the highest performing solution is performed. Systems, storage mediums, and methods of using an neural network trained to be conditioned on an N-dimensional vector are also provided. These methods involve a search process for identifying an N-dimensional vector selected from a vector latent space to obtain a solution for the instance of the optimization problem.

### CROSS-REFERENCE TO RELATED APPLICATIONS

This application claims the benefit of U.S. Provisional Application No. 63/592,408, filed Oct. 23, 2023. The above-referenced patent application is hereby incorporated by reference in its entirety.

### BACKGROUND OF THE INVENTION

### Field of the Invention

The present disclosure relates to neural networks. In particular, but not exclusively, the present disclosure relates to methods and systems for training a neural network to generate solutions to optimization problems and methods and systems for solving optimization problems using neural networks.

### Description of the Related Technology

Optimization, and particularly combinatorial optimization, underpins many real-world applications, including transportation, logistics, energy generation and distribution, and many other applications. Designing systems to solve these complex, typically NP-hard, problems remains a significant research challenge. Reinforcement Learning (RL) is a type of machine learning where an agent learns to make decisions by taking actions in an environment to achieve some goals. The agent learns from the outcomes of its actions, rather than from being taught explicitly. RL systems may be employed to try and solve optimization problems.

### SUMMARY

According to a first aspect of the present disclosure there is provided a method of training a neural network to determine solutions to an optimization problem, the method comprising: obtaining a neural network comprising a plurality of network parameter values defining a policy, wherein the neural network is configured to obtain a state signal representing a state of an instance of the optimization problem and to process state parameters included therein according to the plurality of network parameter values to generate action selection data for selecting an action to be performed by an agent in response to the state signal; obtaining training data representing a plurality of instances of an optimization problem, each instance of the optimization problem being represented by a set of state parameters; and for each instance of the optimization problem in the training data: generating a plurality of solutions for the said instance of the optimization problem, wherein each of the plurality of solutions is generated by: conditioning the policy of the neural network according to an N-dimensional vector; and processing a set of state parameters representing the said instance using the neural network conditioned on the N-dimensional vector whereby to apply the conditioned policy to the said instance of the optimization problem; evaluating each of the plurality of solutions according to a reward function to identify a said N-dimensional vector associated with a highest performing solution; and training the neural network conditioned on the said N-dimensional vector for the said instance of the optimization problem.

The policy represented by the network parameter values may also be referred to as a default policy, or simply, policy, which the network applies when not conditioned according to an N-dimensional vector from the vector latent space. For example, the policy may be represented as π(a|s). Meaning that, when exercised using the neural network, the policy, π, causes the neural network to generate information for determining an action, a, to be selected given a current state, s, of the problem. The conditioned policy is conditional on the vector used and as such can be represented according to π(a|s, z^{→}), meaning that the conditioned policy is used to generate information for determining an action to be selected given a current state of the problem and the latent vector z^{→}. It is additionally noted that while the description refers to combinatorial optimization problems, the methods described may be in a wider example of optimization problems in which solutions, generated using a neural network, are tested against some objective function, a reward is generated, and an optimization is performed to increase the reward obtained by subsequent solutions.

According to a second aspect of the present disclosure there is provided a system configured to train a neural network to determine solutions to an optimization problem, the system comprising at least one processor, and computer-readable storage comprising computer-executable instructions which, when executed by the at least one processor, cause the system to: obtain a neural network comprising a plurality of network parameter values defining a policy, wherein the neural network is configured to obtain a state signal representing a state of an instance of the optimization problem and to process state parameters included therein according to the plurality of network parameter values to generate action selection data for selecting an action to be performed by an agent in response to the state signal; obtain training data representing a plurality of instances of an optimization problem, each instance of the optimization problem being represented by a set of state parameters; and for each instance of the optimization problem in the training data: generate a plurality of solutions for the said instance of the optimization problem, wherein each of the plurality of solutions is generated by: condition the policy of the neural network according to an N-dimensional vector; and process a set of state parameters representing the said instance using the neural network conditioned on the N-dimensional vector whereby to apply the conditioned policy to the said instance of the optimization problem; evaluate each of the plurality of solutions according to a reward function to identify a said N-dimensional vector associated with a highest performing solution; and train the neural network conditioned on the said N-dimensional vector for the said instance of the optimization problem.

According to a third aspect of the present disclosure there is provided a computer-readable non-transitory storage medium on which is stored computer-executable instructions which, when executed by at least one processor, cause the at least one processor to: obtain a neural network comprising a plurality of network parameter values defining a policy, wherein the neural network is configured to obtain a state signal representing a state of an instance of the optimization problem and to process state parameters included therein according to the plurality of network parameter values to generate action selection data for selecting an action to be performed by an agent in response to the state signal; obtain training data representing a plurality of instances of an optimization problem, each instance of the optimization problem being represented by a set of state parameters; and for each instance of the optimization problem in the training data: generate a plurality of solutions for the said instance of the optimization problem, wherein each of the plurality of solutions is generated by: condition the policy of the neural network according to an N-dimensional vector; and process a set of state parameters representing the said instance using the neural network conditioned on the N-dimensional vector whereby to apply the conditioned policy to the said instance of the optimization problem; evaluate each of the plurality of solutions according to a reward function to identify a said N-dimensional vector associated with a highest performing solution; and train the neural network conditioned on the said N-dimensional vector for the said instance of the optimization problem.

According to a fourth aspect of the present disclosure there is provided a method of using a neural network to generate solutions to an optimization problem, the method comprising: obtaining input data representing an instance of an optimization problem, the input data including a set of state parameters; obtaining a neural network comprising a plurality of network parameter values defining a policy, wherein the neural network has been trained to be conditioned on an N-dimensional vector selected from a vector latent space whereby to condition the policy; determining the vector latent space; instructing an agent to implement a search process to identify a desired solution to the instance of the optimization problem, the search process comprising iteratively: selecting an N-dimensional vector; conditioning the policy of the neural network using the selected N-dimensional vector; processing the set of state parameters representing the instance using the neural network conditioned on the N-dimensional vector whereby to apply the conditioned policy to the said instance of the optimization problem to generate a solution; generating a set of solution state parameters representing a solution to an instance of the optimization problem; evaluating the solution according to a reward function; and determining an updated N-dimensional vector to be selected based on the evaluation.

Determining an updated N-dimensional vector to be selected may involve determining an updated N-dimensional vector according to any of a number of procedures. In some examples, the updated N-dimensional vector which is selected is an N-dimensional vector that, when used in coordination with the neural network to generate a solution to the instance of the optimization problem, provides a solution which is higher performing, according to the reward function, than that generated using the previous selected N-dimensional vector. In practice, a search algorithm may be used to refine the selection of the updated N-dimensional vector wherein any single selection of the N-dimensional vector may be worse performing than previously selected N-dimensional vectors, but the general trend is such that the performance of the solutions according to the reward function is improving.

According to a fifth aspect there is provided a system configured to implement a neural network to determine solutions to an optimization problem, the system comprising at least one processor, and computer-readable storage comprising computer-executable instructions which, when executed by the at least one processor, cause the system to: obtain input data representing an instance of an optimization problem, the input data including a set of state parameters; obtain a neural network comprising a plurality of network parameter values defining a policy, wherein the neural network has been trained to be conditioned on an N-dimensional vector selected from a vector latent space whereby to condition the policy; determine the vector latent space; instruct an agent to implement a search process to identify a desired solution to the instance of the optimization problem, the search process comprising iteratively: selecting an N-dimensional vector; conditioning the policy of the neural network using the selected N-dimensional vector; processing the set of state parameters representing the instance using the neural network conditioned on the N-dimensional vector whereby to apply the conditioned policy to the said instance of the optimization problem to generate a solution; generating a set of solution state parameters representing a solution to an instance of the optimization problem; evaluating the solution according to a reward function; and determining an updated N-dimensional vector to be selected based on the evaluation.

According to a sixth aspect of the present disclosure there is provided A computer-readable non-transitory storage medium on which is stored computer-executable instructions which, when executed by at least one processor, cause the at least one processor to: obtain input data representing an instance of an optimization problem, the input data including a set of state parameters; obtain a neural network comprising a plurality of network parameter values defining a policy, wherein the neural network has been trained to be conditioned on an N-dimensional vector selected from a vector latent space whereby to condition the policy; determine the vector latent space; instruct an agent to implement a search process to identify a desired solution to the instance of the optimization problem, the search process comprising iteratively: selecting an N-dimensional vector; conditioning the policy of the neural network using the selected N-dimensional vector; processing the set of state parameters representing the instance using the neural network conditioned on the N-dimensional vector whereby to apply the conditioned policy to the said instance of the optimization problem to generate a solution; generating a set of solution state parameters representing a solution to an instance of the optimization problem; evaluating the solution according to a reward function; and determining an updated N-dimensional vector to be selected based on the evaluation.

### BRIEF DESCRIPTION OF THE DRAWINGS

FIG. 1 is a schematic diagram showing a system according to examples.

FIG. 2 is a schematic diagram showing a neural network according to examples.

FIG. 3 is a flow diagram showing a method of training a neural network according to examples.

FIG. 4 is a schematic diagram showing the method of training a neural network according to examples.

FIG. 5 is a schematic diagram showing an example of sampling an N-dimensional vector from a vector latent space.

FIG. 6A is a schematic diagram showing an example of conditioning a policy of a neural network using an N-dimensional vector.

FIG. 6B is a schematic diagram showing an alternative example of conditioning a policy of a neural network using a N-dimensional vector.

FIG. 7 is a schematic diagram showing a non-transitory computer readable storage comprising computer-executable instructions for performing the method of training a neural network.

FIG. 8 is a schematic diagram showing a system according to examples.

FIG. 9 is a flow diagram showing a method of using a neural network to generate solutions to an instance of an optimization problem according to examples.

FIG. 10 is a schematic diagram showing the method of using the neural network to generate solutions to an instance of an optimization problem according to examples.

FIG. 11 is a schematic diagram showing a method of using the neural network, wherein an evolutionary algorithm is used, according to examples.

FIG. 12 is a schematic diagram showing a non-transitory computer readable storage comprising computer-executable instructions for performing the method of using the neural network.

### DETAILED DESCRIPTION OF CERTAIN INVENTIVE EMBODIMENTS

Reinforcement Learning (RL) is a type of machine learning where an agent learns to make decisions by taking actions in an environment to achieve some goal. The agent learns from the outcomes of its actions, rather than from being taught explicitly. The agent tries to determine the best actions to take in a given situation to maximize a reward signal.

In the context of machine learning an “agent” refers to an entity or software component that makes decisions or takes actions in an environment to achieve certain goals. The concept of an agent is central to reinforcement learning and is defined by its ability to perceive its environment through data representing the environment and act upon that environment by selecting actions to be taken.

Agents in machine learning are designed to learn optimal behaviors or policies through interactions with their environment. These interactions are based on the principles of trial and error, where the agent receives feedback in the form of rewards or penalties based on the actions it takes. The goal of the agent is to maximize the cumulative reward it receives over time.

The environment is a representation of the task, or world, in which the agent moves by selecting actions. Actions, a, refer to possible moves, or decisions, that an agent makes with respect to their environment. Selecting an action moves the environment from a first state to a second, different, state, wherein a state, s, represents a specific configuration of the environment.

A reward, R, representing feedback with respect to the agent's selected action may be sent back from the environment to the agent. A policy, π, is a strategy or behavior that the agent employs to determine a next action, a, based on the current state, s, of the environment. Value, V, represents an expected long-term return, in contrast to the short-term reward, R. Q-value, Q, is similar to the Value, V, but generally refers more specifically to the long-term return of taking action, a, in a state, s.

An RL agent is typically tasked with learning a policy, π, that maximizes a cumulative reward over the long term. For example, where an RL agent is configured with determining solutions to a specified problem, the RL agent may be tasked with learning a policy, π, that maximizes the cumulative reward from an initial state of the specified problem to a proposed solution represented by a sequence of actions, a, selected by the agent. A number of RL methods may be used including, but not limited to, Q-learning, Deep Q Network (DQN), Policy Gradients, and Actor-Critic methods.

An agent may include, or use, a neural network that is configured to represent the policy, π, of the agent. For example, the neural network may include a plurality of network parameter values, such as weight values, that represent the policy, π, of the agent. During an RL process, the policy of the agent, π, may be updated by modifying the network parameter values of the neural network.

As briefly discussed above, machine learning models that use reinforcement learning have been applied to real-world optimization problems. Reinforcement learning techniques are generally considered to be well suited to solving optimization problems due to several of its characteristics. RL techniques are suited to trial and error learning, which is naturally aligned with optimization, as it seeks to find the best possible actions (decisions) to maximize or minimize a specific objective (reward). Trial and error learning enables agents to be trained without supervision. Supervision, in the context of optimization, is generally computationally expensive and hence undesirable.

Optimization problems can often be framed as a series of decisions that are interdependent. RL can excel in such contexts because it considers the entire sequence of actions and their long-term outcomes, rather than optimizing each decision in isolation. RL techniques are often highly scalable and adaptable, are capable of learning from sparse and delayed feedback, and can be easily integrated with simulation environments in which solutions can be tested and developed rapidly.

While RL provides sophisticated and promising techniques that can be applied to a wide range of real-world applications, the resources and energy expenditure used to develop models based on RL techniques can be high. It often takes a large number of interactions with an environment for RL techniques to produce effective policies which can be practical in real-world settings. Agents, such as those trained using RL techniques, can also perform poorly with respect to generalization across tasks. RL agents, trained in a specific environment or task, may not perform well when the environment changes slightly or when applied to a different but related task. For example, where a task addressed during inference is outside of the distribution (OOD) used to train the policy of the RL agent, the agent may struggle with producing an effective solution.

Attempts to apply machine learning systems to a variety of tasks, in view of the difficulties in producing models that are more generalizable, have involved training separate models for each specific task, further increasing the already burdensome computational and data requirements. This approach has also been applied when developing machine learning systems for solving different instances of the same task. For example, where the task to be solved is a route optimization for logistics, an RL agent trained on a specific route optimization task, or set of tasks, may not perform well in a different route optimization task.

The goal of some types of optimization problems, specifically combinatorial optimization problems, may be formulated as an attempt to find an optimal labeling of a set of discrete variables that satisfy the problem's constraints. A single attempt to solve a given instance of a combinatorial optimization problem, starting from an initial state of the environment and ending in a terminal state of the environment, may be referred to as an episode. In RL, combinatorial optimization problems can be formulated as Markov Decision Processes (MDP) represented by M=(S, A, R, T, γ, H). This includes the state space S, with states sᵢ∈S, action space A with actions aᵢ∈A, reward function rᵢ=R (sᵢ, aᵢ), transition function sᵢ₊₁=T(sᵢ, aᵢ), discount factor γ∈[0,1], and horizon H which denotes the episode duration.

The state of a problem instance can be represented as the (partial) trajectory or set of actions taken in the instance, and the next state sₜ₊₁ is determined by applying a chosen action aₜ to the current state sₜ. An agent is introduced in the MDP to interact with the optimization problem and find solutions by learning a policy π: S→A. The policy is trained to maximize the expected sum of discounted rewards to find the optimal solution, and this is formalized as the following learning objective:

$$π ⋆ = {arg max}_{π} E [ {Σ}_{t = 0}^{H} {γ}^{t} R ( {s}_{t} , {a}_{t} ) ] .$$

Certain examples, described herein, provide systems and methods of training neural networks to learn a latent space of diverse policies that can be explored at inference time to find a better performing strategy for a given instance. This makes the neural network more generalizable across different instances of a given optimization problem, and better suited to inference time searching. The techniques described herein may be referred to as COMbinatorial Optimization with Policy Adaptation using Latent Space Search (COMPASS).

These methods involve training the neural network such that, when conditioned on an N-dimensional vector, the neural network is adapted to solve a subset of instances, or types, of a given optimization problem. When conditioned on a different N-dimensional vector, the neural network is adapted to solve a different subset of instances, or types, of the given optimization problem. Corresponding methods and systems, relating to the use of such a neural network in inference, are also described herein.

In this way, a single neural network may implement a plurality of diverse solvers by using a single conditioned policy, and sampling the conditions from a latent space. The training process may encourage subareas of the latent space to specialize to sub-distributions of instances of an optimization problem, and this diversity is used at inference time to solve newly encountered instances of the optimization problem.

### Training

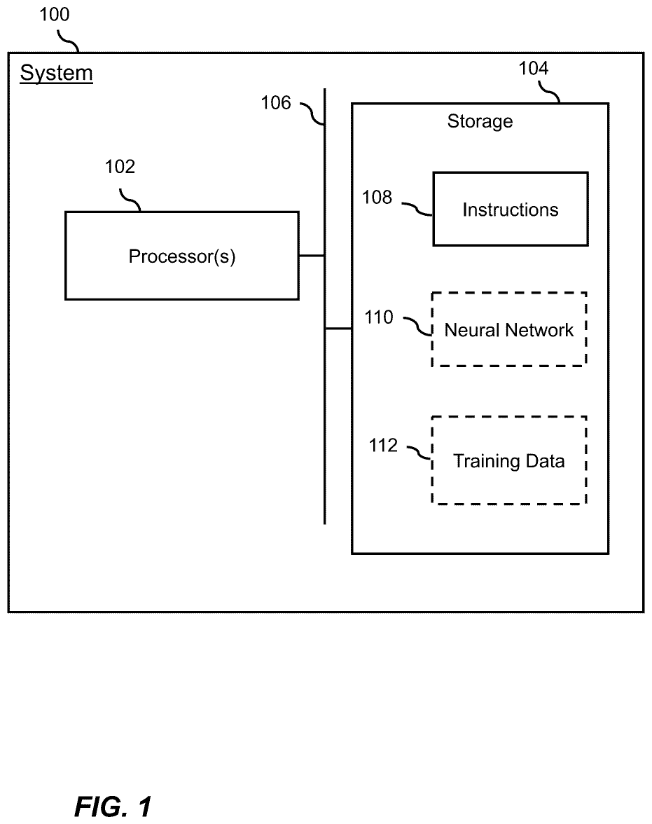

FIG. 1 shows a system 100 configured to train a neural network to determine solutions to an optimization problem. The system 100 comprises at least one processor 102 and computer readable-storage 104. The processor(s) 102 and storage 104 are connected over a communication channel, such as a bus 106, allowing them to communicate with each other. In the example shown, the system 100 is implemented as a single unit or computing device. However, it will be appreciated that in other examples, the system 100 may comprise a plurality of communicatively coupled, but physically separated, computing devices.

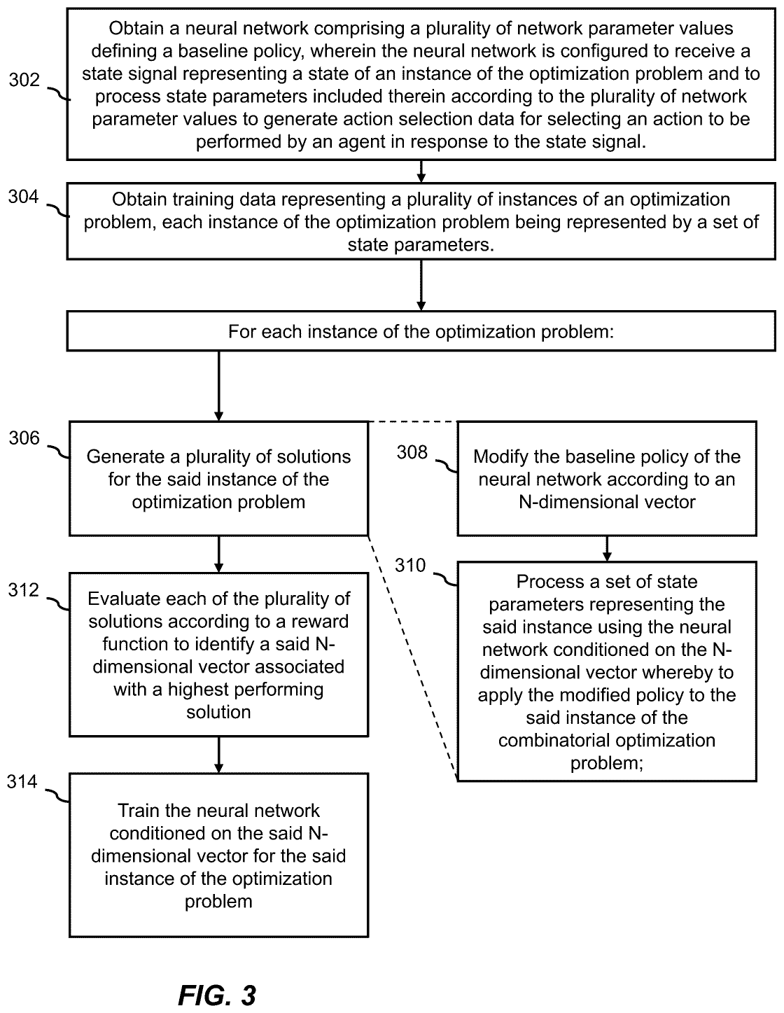

The storage 104 comprises computer-executable instructions 108. When executed by the processor(s) 102, the computer executable instructions 108 cause the system 100 to perform a method of training the neural network to determine solutions to the optimization problem, which will be described below with respect to FIGS. 3 to 6. The storage 104 is may also be capable of storing other types of data for example data representing a neural network 110 and/or training data 112 for training the neural network 110.

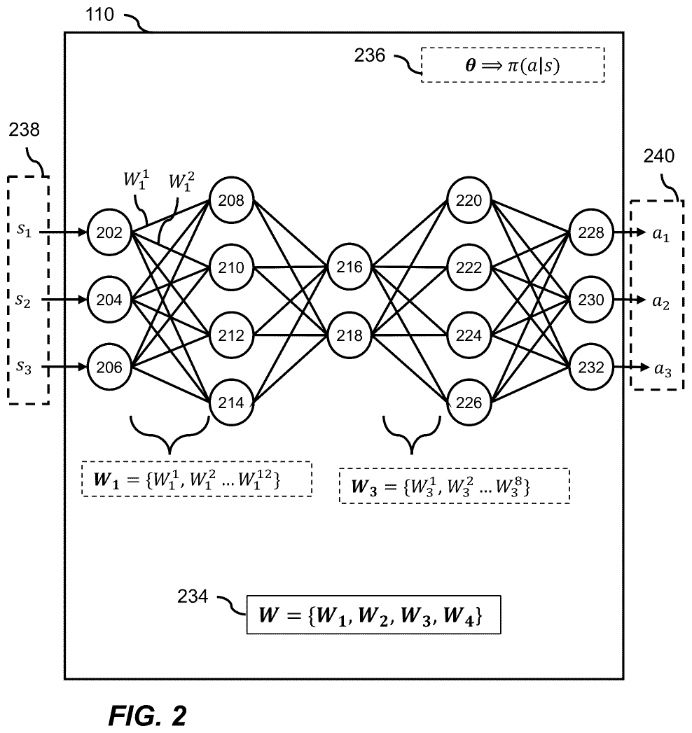

An example of the neural network 110 will now be described with reference to FIG. 2. The neural network 110 comprises a plurality of layers each layer comprising a respective set of neurons 202 to 232 that are connected to adjacent layers according to a set of weights, W, 234. For simplicity only some of the weights are labeled in the example shown in FIG. 2. In particular a first set of weights W₁ connecting an input layer comprising three neurons 202 to 206 to a second layer comprising four neurons 208 to 214 is shown. A third set of weights W₃ connecting a third layer with a fourth layer of the network 110 is also shown.

The neural network 110 comprises a plurality of network parameter values 236, θ, that include the weight values 234 and define a policy π(a|s). The network parameter values 236, θ, may include additional parameters such as bias values, or parameters used to define operations such as padding, polling, or other relevant operations that may be performed in the network 110.

The neural network 110 is configured to obtain a state signal 238 representing a state of an instance of an optimization problem. The state signal 238 includes state parameters (s₁, s₂, s₃) that represent the state of the instance of the optimization problem. For example, where the optimization problem is a box packing problem, relevant to real-world logistics applications, the instance of the optimization problem may be distinguished from other instances by the sizes and shapes of the boxes to be packed, a shape and volume of a packing area in which the boxes are to be packed, and the positions of any boxes already position in the packing area. In this context, the state parameters (s₁, s₂, s₃) may be values used to represent these conditions in the state of the optimization problem. In other examples, such as where the optimization problem is the control of a manufacturing process or factory, the state parameters (s₁, s₂, s₃) may represent conditions, or operational modes, of various pieces of equipment or control parameters used in the manufacturing process.

The neural network 110 is configured to process the state parameters according to the plurality of network parameter values 236, 0, to generate action selection data 240 for selecting an action to be performed by an agent in response to the state signal 238. In this context, the agent that is configured to select actions based on the action selection data 240 comprises the neural network 110. However, in other examples, the agent may be an entity that uses the action selection data 240 generated by the neural network 110 but does not include the neural network 110.

It is to be appreciated that the neural network 110 described with respect to the example shown in FIG. 2 is not intended to be limiting with respect to the network configuration or architecture. The examples described herein, while referring to the example network 110 of FIG. 2, may be implemented using any suitable neural network including, but not limited to, feedforward neural networks (FFNs), convolutional neural networks (CNNs), recurrent neural networks (RNNs), long short-term memory (LSTM) networks, generative adversarial networks (GANs), autoencoders, radial basis function (RBF) networks, modular neural networks, sequence to sequence models, multi-head attention networks, and transformer networks.

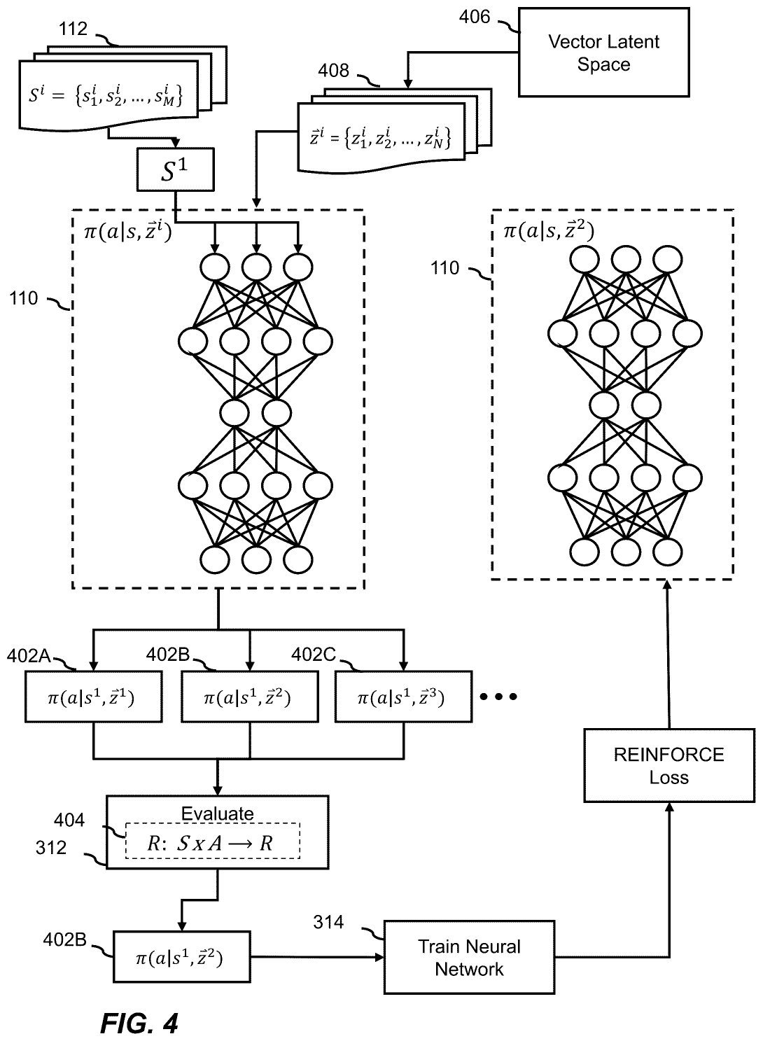

The method 300 of training the neural network 110 will now be described with reference to FIGS. 3 and 4. The method 300 comprises obtaining 302 the neural network 110. Where the neural network 110 is stored in the storage 104, obtaining 302 may involve accessing the storage 104 to obtain the neural network 110. In other examples, the neural network 110 may be stored remotely and requested and/or received by the system 100.

The system 100 obtains 304 training data 112 representing a plurality of instances of an optimization problem. Each instance of the optimization problem is represented by a set of state parameters Sⁱ={s₁ⁱ, s₂ⁱ, . . . , s_{M}ⁱ}, wherein the superscript i indicates the specific instance to which the state parameters Sⁱ relate. In FIG. 4 a first instance represented by state parameters S¹ is used. For each instance of the optimization problem, the system 100 generates 306 a plurality of solutions 402A to 402C for the said instance.

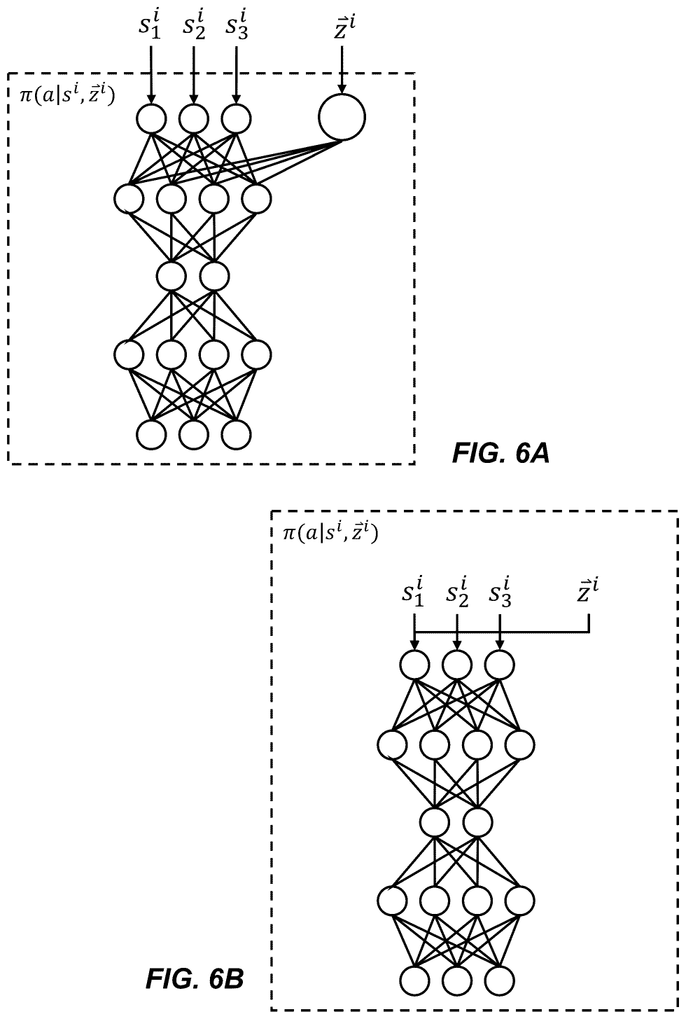

Generating 306 the plurality of solutions 402A to 402C comprises conditioning 308 the policy of the neural network 110 according to an N-dimensional vector, z^{→i}. The policy of the neural network 110, as conditioned on the N-dimensional vector, z^{→i}, may be expressed according to π(a|s, z^{→i}). Techniques for conditioning the policy of the neural network 110 according to an N-dimensional vector, z^{→i}, will be discussed below with reference to FIGS. 6A and 6B.

The set of state parameters S¹ are processed 310 using the neural network 110 conditioned on the N-dimensional vector z^{→i} whereby to apply the conditioned policy to the instance of the optimization problem. A first solution 402A is generated by conditioning the neural network 110 on a first N-dimensional vector z^{→1}. When the state signals S¹ are processed using the neural network conditioned on vector z^{→1}, the solution 402A is determined according to a first conditioned policy π(a|s, z^{→1}) of the neural network 110. This is repeated for the plurality of N-dimensional vectors 408, wherein two such additional solutions 402B and 402C are shown in FIG. 4, the N-dimensional vectors being z^{→2}, and z^{→3} respectively.

The plurality of solutions 402A to 402C are evaluated 312 according to a reward function 404 to identify an N-dimensional vector z^{→2}-associated with the highest performing solution 402B. The neural network 110 as conditioned on the N-dimensional vector z^{→2} is then trained 314 for the current instance of the optimization problem.

In this way, the policy of the neural network 110 is conditioned on a current observation, or state, and on samples drawn from a vector latent space. The training objective may encourage this latent space of policies to be diverse, for example generating a wide range of behaviors, and specialized. For example, the behaviors may be optimized for different types of problem instances from the training distribution.

Training the neural network 110 to implement a single conditional policy, in which the behavior of the network's 110 policy is dependent on an N-dimensional vector sampled from a vector latent space, enables a single neural network 110 to be trained for a given type of optimization problem. A neural network 110 trained in this manner may exhibit similar, or increased, specialization compared to other techniques in which multiple, uniquely parametrized, neural networks are trained on different instances of a type of optimization problem.

The training method 300 described above is less computationally expensive and mitigates the significant training and memory overheads associated with training a population of neural networks for a given optimization problem. Using a single neural network 110 trained for policy adaptation when conditioned on an N-dimensional vector may also reduce the storage requirements when used for inference. This is because a single neural network 110, rather than a plurality of neural networks, may be provided in a system configured to solve the optimization problem. Additionally, by training the neural network 110 as conditioned on a respective N-dimensional vector z^{→2}, for the given instance of the optimization problem, a structured vector latent space is obtained. This structured vector latent space enables principled search processes to be applied during inference. In some instances, the structured vector latent space may be structured such that similar policies are obtained by using the vectors that are in close proximity to one another.

The N-dimensional vectors 408 used to generate 306 the plurality of solutions may be selected from a vector latent space 406. The method 300 may comprise determining the vector latent space 406 from which these N-dimensional vectors 408 are selected. The vector latent space 406 that is determined will influence the magnitude, and/or effectiveness, of conditioning the policy of the neural network 110 using a respective N-dimensional vector z^{→i}. The determination of the vector latent space 406 may depend on the optimization problem to be solved, the architecture of the neural network 110, the characteristics of the set of state parameters defining an instance of the problem, the diversity of potential strategies for solving the optimization problem, and the manner in which the policy is to be conditioned using the N-dimensional vectors 408. Accordingly, the vector latent space 406 may be configured, or adapted, for use in a particular type of optimization problem.

Determining the vector latent space 406 may involve an iterative process in which an initial vector latent space 406 is determined, the method 300 is performed and a performance of the neural network 110 is evaluated. The vector latent space 406 may be updated based on this evaluation to determine a vector latent space 406 that is better suited to the optimization problem and/or the network architecture.

Determining the vector latent space 406 may comprise selecting one or mor characteristics which can be used to define or represent the vector latent space 406. These characteristics may include a number of dimensions and/or a precision of each dimension that is to be defined for the vector latent space 406. In the example of FIG. 4, a general “N” dimensional vector latent space is shown. The number of dimensions to be used may be correlated with the complexity of the optimization problem, and/or the variability in instances of the optimization problem and the target solutions. The complexity and/or variability of the vector latent space 406 may be configured to correlate with the variability in the instance's optimization problem, such that the neural network 110 may be capable of specializing with a high precision. The characteristics of the vector latent space 406 may include an upper and lower limit for each dimension of the vector latent space 406.

In some examples, determining the vector latent space 406 may comprise selecting a distribution of values for each dimension. Selecting a distribution may involve defining a function, or rule, by which vectors having the selected number of dimensions can be generated.

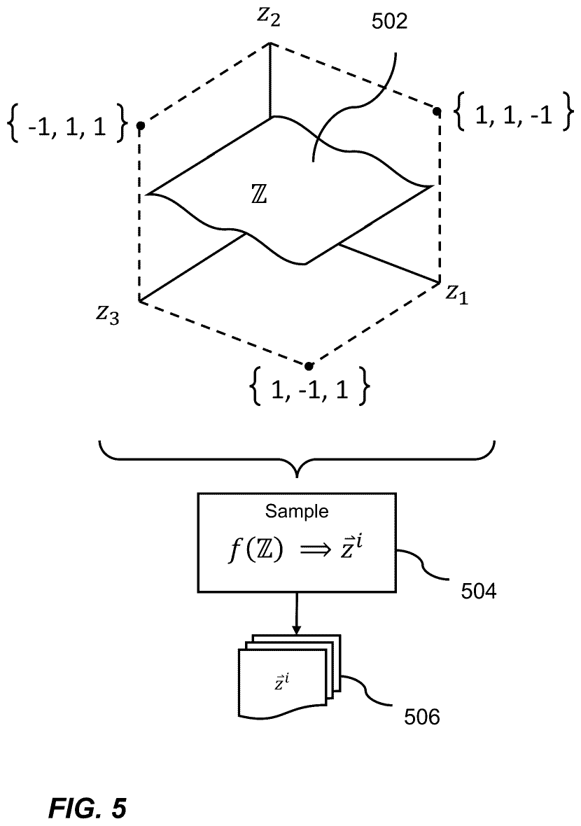

The N-dimensional vectors 408 which are selected from the vector latent space 406 for use in the method 300 may be sampled from vector latent space 406. FIG. 5 shows an example in which the vector latent space 502 comprises three dimensions. The vector latent space 502 is represented according to a continuous function Z. A sampling function 504 is used to sample vectors 506 from the three-dimensional vector latent space 502. The number of vectors 506 which are obtained by the sampling may be configurable. For example, where computational resources are limited, and/or where the complexity of the instance of the optimization problem is low, few N-dimensional vectors 506 may be sampled.

In some examples, the sampling function 504 may comprise applying a uniform distribution to the vector latent space 502 and selecting the set of vectors 506 based on the distribution function. Uniform distributions enable a broad range of vectors to be sampled from the vector latent space 502, and may mitigate the introduction of bias or overtraining the neural network 110 on a particular region, or sub-space of the vector latent space 502.

Returning to FIG. 4, training 314 the neural network 110 conditioned on the N-dimensional vector z^{→2} for the given instance of the optimization problem may comprise determining a loss for the respective solution using a loss function and training the neural network 110 conditioned on the N-dimensional vector based on the determined loss. In other words, the policy of network 110 as conditioned on the N-dimensional vector z^{→2} may be trained based on the loss, rather than training the unconditioned policy of the neural network 110. Training 314 the neural network 110 may comprise backpropagation using gradient descent, or other suitable training process.

The training 314 procedure aims to specialize subareas of the vector latent space 502 to sub-distributions of instances of the optimization problem by training the policy of the network 110 when conditioned according to the vectors that are high performing on a given instance. The training 314 may involve updating the neural network 110 using the gradient of an objective given by (it is noted that the representation of certain elements in the expression below is different to those use in the prior description for simplicity and to aid understanding—the relevant definitions are provided below):

$${∇}_{θ} {J}_{c o m p a s s} = {E}_{ρ ∼ D} {E}_{{z}_{1 …} {z}_{N} ∼ Z} {E}_{{τ}_{i} {π}_{θ} ( . \vert {z}_{i} )} [ {∇}_{θ} log {π}_{θ} ( {τ}_{i *} \vert {z}_{i *} ) ( {R}_{{i}^{*}} - {B}_{ρ , θ} ) ]$$

Where D is the data distribution, Z is the latent space, zᵢ is a latent vector, π_{θ} the conditioned policy, τᵢ is the trajectory generated by policy π_{θ} conditioned on vector zᵢ and has corresponding reward R_{i*}, i* is the index of the best performing latent vector (in the sampled set) and is expressed as i*=argmax_{i∈[1,N]}R(τᵢ), and B_{ρ,θ} is the baseline.

Examples of conditioning 308 the policy of the neural network 110, based on an N-dimensional vector z^{→i}, are shown in FIGS. 6A and 6B. In the example of FIG. 6A, conditioning 308 the neural network's 110 policy comprises providing one or more neurons at which the N-dimensional vector z^{→i} can be inserted. The N-dimensional vector z^{→i} may be treated as another input to the neural network 110 similar to the state parameters (s₁ⁱ, s₂ⁱ, s₃ⁱ). Wherein the N-dimensional vector z^{→i} may be processed using the weights W and incorporated into neurons of the second layer of the neural network 110.

In the example shown in FIG. 6B, conditioning 308 the policy of the neural network 110 comprises concatenating the N-dimensional vector z^{→i} with the set of state parameters (s₁ⁱ, s₂ⁱ, s₃ⁱ) representing the instance of the optimization problem. Concatenating, in this context, may involve any suitable operation such as convolutional operations. The state parameters (s₁ⁱ, s₂ⁱ, s₃ⁱ) may be convolved or multiplied by the N-dimensional vector z^{→i}. The N-dimensional vector z^{→i} may be concatenated with all, or a sub-set of, the state parameters (s₁ⁱ, s₂ⁱ, s₃ⁱ).

While not shown in the Figures, it will be appreciated that, in the examples described above, to condition the policy of the neural network 110, the structure or other characteristics of the neural network 110 may be adapted for this purpose. For example, compared to a similar neural network that is not adapted to have the policy conditioned on an N-dimensional vector z^{→i}, the neural network 110 may have a different configuration of input neurons and/or weight values. This may include having a number of neurons, or a dimensionality at each neuron, that is adapted to enable a selected N-dimensional vector z^{→i} to be inserted into the neural network 110. In the example of FIG. 6A, the neural network 110 comprises weight values which are suitable for enabling the N-dimensional vector z^{→i} to be provided as an input to the neural network 110. In the example of FIG. 6B, the neurons at the input layer of the neural network 110 may be configured to receive an input that has the same characteristics as the result of the concatenation between the set of state parameters (s₁ⁱ, s₂ⁱ, s₃ⁱ) and the N-dimensional vector z^{→i}.

It is to be appreciated that other examples of conditioning the neural network 110 on the N-dimensional vector (not shown), are also possible. In some cases, the operation used to condition the neural network 110 may modify a property, such as the dimensionality or total number, of the state parameters (s₁ⁱ, s₂ⁱ, s₃ⁱ).

While two examples of conditioning the policy of the neural network 110 are shown, it is to be appreciated that other examples are contemplated. For example, the N-dimensional vector may be used to modify one or more other characteristics of the neural network 110, such as a bias in a layer, pooling operations, padding, or being used to modify weights according to a predetermined function. In some examples, conditioning the policy of the neural network 110 may involve modifying the policy of the neural network 110 for example by changing one or more parameter values of the neural network 110.

In some examples, the method 300 comprises pre-training the neural network 110 prior to training the neural network according to the steps 306 to 310 described above. This pre-training may involve training the neural network 110 to generate solutions to the optimization problem according to a reinforcement learning training procedure. Pre-training the neural network 110, without policy adaptation using vector latent spaces, may reduce the time needed to train the neural network 110 with policy adaptation, because the neural network 110 may already have a policy that is relatively efficient at solving the optimization problem.

Where the neural network 110 is pre-trained, the method 300 may comprise conditioning the pre-trained neural network 110 by adding a further set of parameter values, such as weights. In this example, conditioning 308 the policy of the neural network may comprise modifying the further set of parameter values according to the respective N-dimensional vector. In this way a general neural network 110 trained to solve the optimization problem may be used without requiring a completely new neural network to be developed. In other examples, the further set of parameter values may be added prior to pre-training the neural network 110.

The training data 112 may be segmented into batches of instances of the optimization and the neural network 110 trained in batches. Training the neural network 110 using batches of instances may enable the performance of the neural network to be monitored and the training process reconfigured if suitable. In some cases, the instances of the optimization problem may be separated into batches based on variability of their respective set of state signals, Sⁱ. In this way, the neural network 110 may be trained on a broad range of variable instances of the problem in any given batch, mitigating the potential for overtraining of the neural network 110. The batch size may be selected, such that the computational expense and resources may be managed and controlled during the training process.

As described above, each of the plurality of solutions 402A to 402C generated for a given instance of the optimization problem are associated with a respective N-dimensional vector z^{→i} used to condition the policy of the neural network 110 when generating the respective solution 402A to 402C. The method 300 may involve selecting a number of N-dimensional vectors z^{→i} that are to be used to generate the plurality of solutions 402A to 402C. In this way, the resources used to train the neural network 110 may be controlled. In some examples, the number of N-dimensional vectors z^{→i} to be selected may be dependent on the available resources in the system 100, the complexity of the optimization problem.

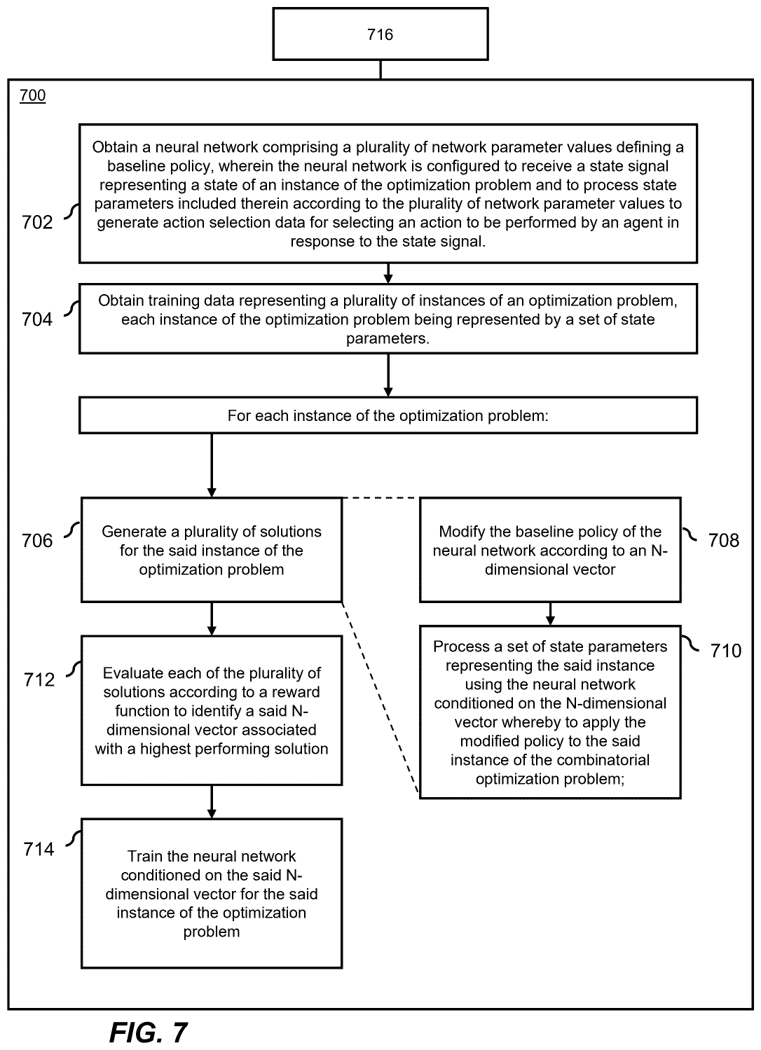

FIG. 7 shows a non-transitory computer-readable storage medium 700 comprising computer executable instructions 702 to 714 which, when executed by a processor 716, cause the processor to perform the method 300 described above. The examples of the method 300 described above may also apply to the method as performed by the processor 716 based on the instructions 702 to 714.

### Inference

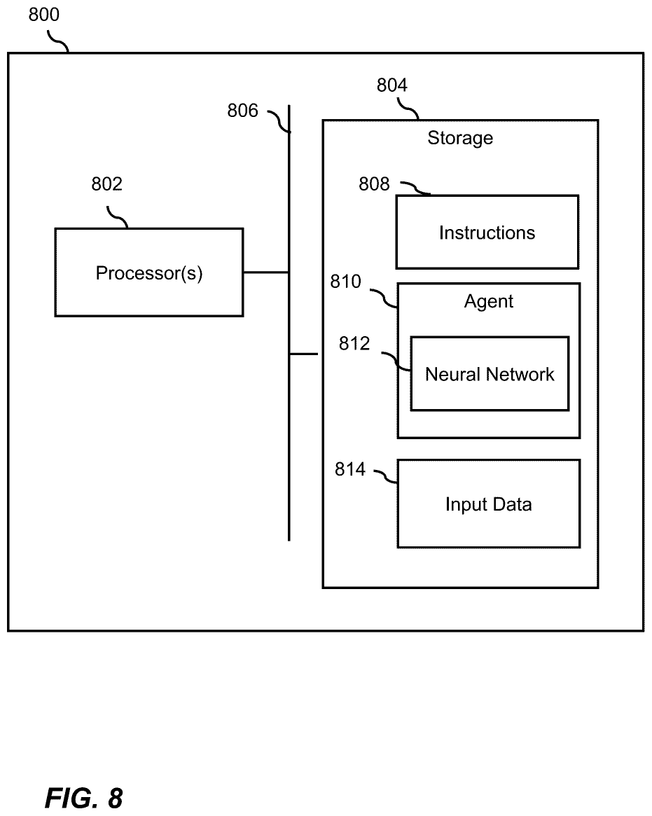

FIG. 8 shows a system 800 configured to implement a neural network to determine solutions to an optimization problem. The system 800 is similar to the system 100 described with reference to FIG. 1 and comprises at least one processor 802 and computer readable-storage 804. The processor(s) 802 and storage 804 are connected over a communication channel, such as a bus 806, allowing them to communicate with each other.

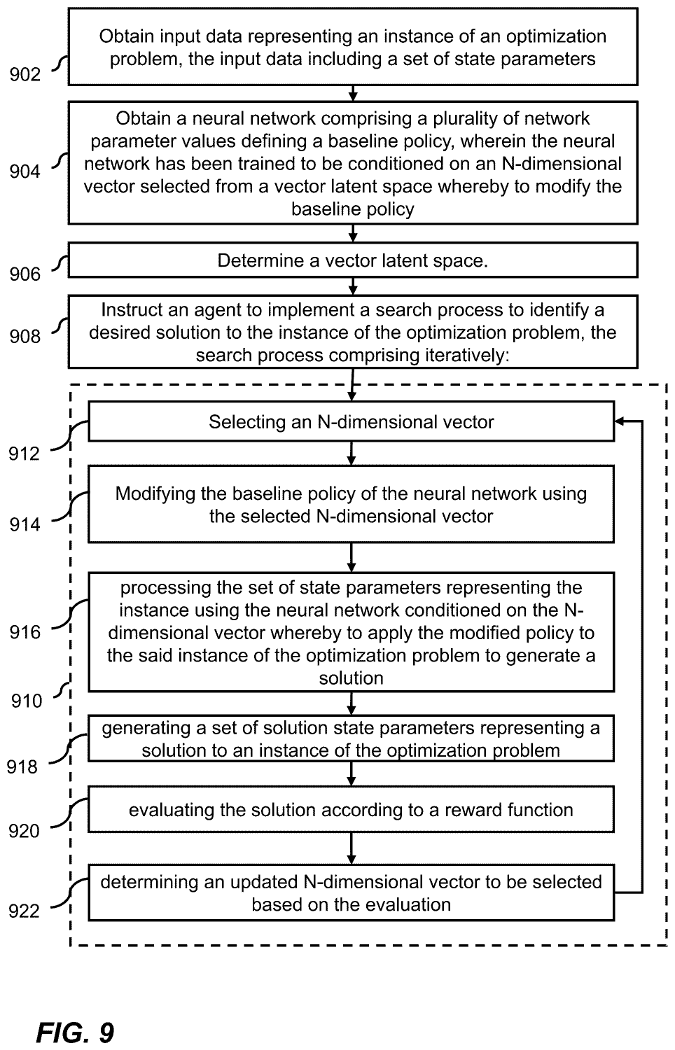

The storage 804 comprises computer-executable instructions 808 which, when executed by the processor(s) 802, cause the system 800 to perform a method of using a neural network to generate solutions to an optimization problem, which will be described below with respect to FIGS. 9 to 11. The storage 804 is may also be capable of storing other types of data, such as instructions, or program code, for implementing an agent 810, a neural network 812, and/or input data 814 representing an instance of the optimization problem.

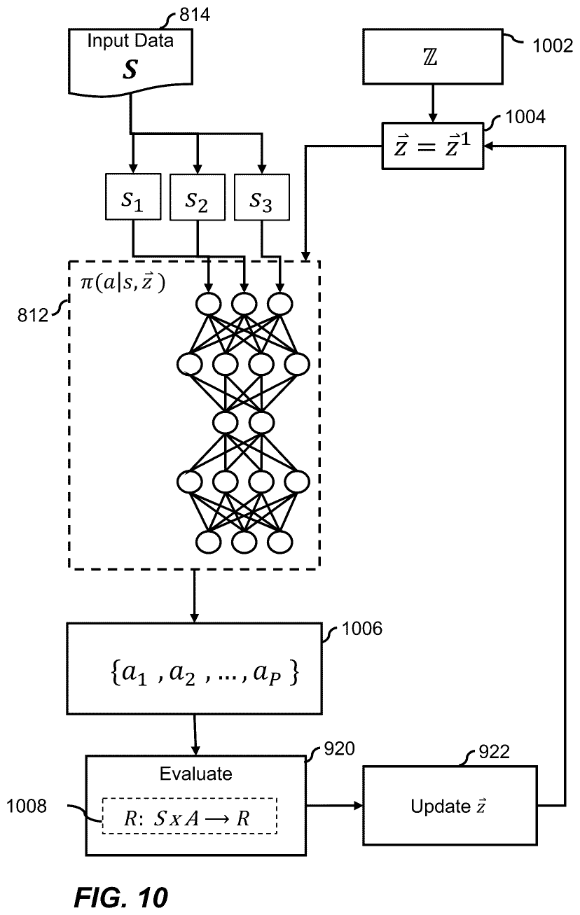

The method 900 of using the neural network 812 will now be described with reference to FIGS. 9 and 10. The system 800 obtains 902 input data 814 representing an instance of an optimization problem, the input data 814 including a set of state parameters S. It is noted that the while the symbol S is similar to symbols used to refer to the set of state parameters described with respect to the method 300 of training a neural network 110, the input data 814 generally represents instances of a problem that are outside of the instances represented in the training data 112.

A neural network 812 comprising a plurality of network parameter values defining a policy π(a|s) is obtained 904. Where the neural network 812 is stored in the storage 804, obtaining 904 the neural network 812 comprises access the storage 804. The neural network 812 has been trained to be conditioned on an N-dimensional vector z^{→} selected from a vector latent space 1002 such that the policy π(a|s) of the neural network 812 can be conditioned using the N-dimensional vector z^{→}. For simplicity, the neural network 812 referred to in the present example is a trained neural network 812 that is produced by training the neural network 110 according to the methods 300 described above with respect to FIGS. 3 to 6. However, it is to be appreciated that other methods of training a neural network 812 to be conditioned on an N-dimensional vector z^{→} selected from a vector latent space 1002 may alternatively, or additionally, be used.

The system 800 determines 906 the vector latent space 1002 for which the neural network 812 has been trained. In some cases, the neural network 812 may be stored with an indication of one or more characteristics of the vector latent space 1002, in which case, determining the vector latent space 1002 comprises identifying these characteristics from a stored indication.

An agent 810 is instructed 908 to implement a search process 910 to identify a desired solution to the instance of the optimization problem. The agent 810 in this example comprises the neural network 812. However, it will be appreciated that in other examples, the agent 810 may not include the neural network 812, but may be capable of communicating with, or otherwise using, the neural network 812 to determine solutions to instances of an optimization problem.

The search process 910 is an iterative process that is configured to refine a selection of an N-dimensional vector 1004 that, when used to condition the policy of the neural network π(a|s, z^{→}), enables the neural network 812 to generate a solution to the optimization problem that satisfies one or more criteria. A first iteration of the search process 910, shown in FIG. 10, comprises selecting 912 an N-dimensional vector, z^{→}=z^{→1}, 1004 from the vector latent space 1002. The policy π(a|s) of the neural network 812 is the conditioned 914 using the selected N-dimensional vector z^{→}. Conditioning the neural network 812 may involve one of the techniques described above with respect to FIGS. 6A and 6B.

The set of state parameters S representing the instance of the optimization problem are processed 916 using the neural network 812 conditioned on the N-dimensional vector 1004, such that neural network 812 implements a policy π(a|s, z^{→}) associated with the selected N-dimensional vector z^{→1}. As such, the conditioned policy π(a|s, z^{→}) is applied to the instance of the optimization problem to generate a solution 1006.

The solution 1006 that is generated 918 includes a set of solution state parameters {a₁, a₂, . . . , a_{P}} representing a solution to the instance of the optimization problem. The solution 1006 is evaluated 920 according to a reward function 1008. Based on an outcome of the evaluation 920, an updated N-dimensional vector that is to be selected in a subsequent iteration of the search process 910 is determined 922. Providing an inference time search algorithm that leverages a vector latent space in this way, enables a single neural network 812 to be trained to implement a plurality of policies, and thereby increase the generalizability and specialization of the neural network 812. By iteratively performing this method 900, the system 800 is able to converge on a solution to the optimization problem that satisfies one or more desired characteristics, or criteria, by searching through the vector latent space 1002 and without requiring the system 800 to update, or retrain, the neural network 812. As described above, retraining a neural network 812, or providing a plurality of neural networks that are trained on specific instances of optimization problems, is computationally expensive and resource intensive, and hence the proposed methods 300 and 900 enable efficient and fast implementations of neural networks 812 in a number of real-world applications.

When implementing the method 900, the agent 810 may be provided with a predetermined search budget, and in that case the search process 910 is performed until the predetermined search budget is exhausted. The predetermined search budget may represent a restriction on the number of solutions that can be generated before a solution to the instance of the optimization problem is selected. Once the predetermined search budget is exhausted, a solution to the optimization problem may be selected from a plurality of solutions generated during the search process 910.

The search budget may be represented according to any suitable restriction, which may depend on the specific system 800 or optimization problem to be solved. The search budget may include: a specified number of times the search process can be performed; a predetermined time period during which the search process 910 can be performed; a predetermined amount of computing resources which may be used to perform the search process 910; or any suitable combination of these. In this way, it is possible to tune the application of the method 900 based on the resources in the system 800, other workloads to be performed by the system 800, and/or time constraints when implementing the method 900 to generate a solution to the instance of optimization problem. This may be particularly useful where the system 800 is integrated into a real-world implementation in which there are real hardware and/or time constraints.

For example, where the system 800 is implemented in a portable computing device, such as an autonomous vehicle, mobile computing device, IoT device, or others, there may be limited hardware resources for implementing the method 900. Some applications may be time critical, for example, where the instance of the optimization problem relates to a real-world environment or task, the system 800 may be configured to produce a solution within a specified time limit, such as before the state of the real-world environment changes.

Where the system 800 is configured to generate solutions to real-world problems, the input data 814 may comprise, or be derived from, sensor data. For example, one or more sensors may be used to generate sensor data representing a state of a real-world environment in which a specific task or problem is to be solved. The system 800 may be part of a control system that is configured to control equipment to achieve a certain goal. The system 800 may be employed in any of a number of such situations, for example, for controlling a manufacturing process, operating a vehicle, communicating with one or more users, and so forth. In these examples, the solutions may represent outputs, or control characteristics, to be used to interact with the real-world environment.

Where the system 800 is configured to generate solutions that can be used to control real-world environments, the neural network 812 may be trained based on real-world data. For example, evaluating a solution may involve comparing the solution to actual control data used to operate the real-world environment. Alternatively, the solutions may be used to control the actual real-world environment, and the performance of the real-world environment may be scored and used to train the neural network 812. In other examples, the neural network 812 may be trained according to a virtual environment that closely replicates a real-world environment, such that the neural network 812, after being trained in the virtual environment, is suitable for application in real-world environments.

Determining 922 an updated N-dimensional vector 1004 may be performed in a manner that aims to increase a reward obtained by the reward function 1008 in the subsequent iteration of the search process 910. In the example shown in FIG. 10, a reward function 1008 is shown as an example. It will be appreciated, however, that the reward function may additionally, or alternatively, involve other reward functions such as long-term expected reward functions based on Value, V, or Q-value, Q.

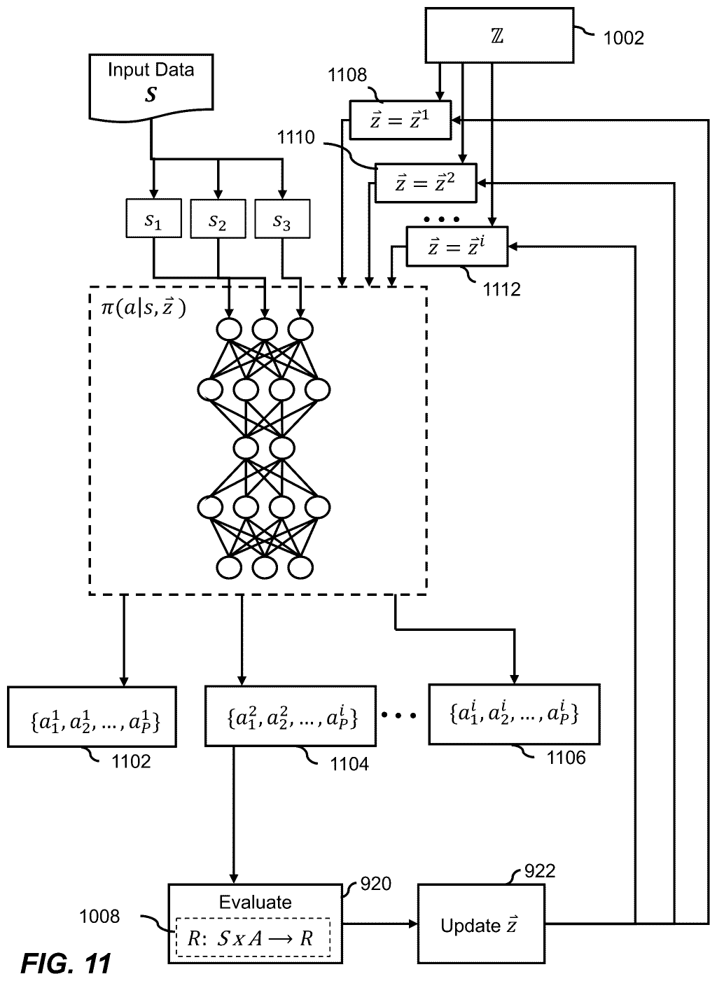

The search process 910 may comprise applying an evolutionary algorithm to identify updated N-dimensional vectors 1004 to be selected. FIG. 11 shows an example in which an evolutionary algorithm may be applied. The evolutionary algorithm involves generating a plurality of solutions 1102 to 1106 based on a plurality of selected N-dimensional vectors 1108 to 1112. The plurality of solutions 1102 to 1106 are then evaluated, and an evolutionary algorithm may be used to determine updated N-dimensional vectors 1108 to 1112. Evolutionary algorithms use mechanisms inspired by biological evolution, such as reproduction, mutation, recombination, and selection. Candidate solutions to the optimization problem play the role of individuals in a population, and a fitness function determines the quality of the solutions (or how “fit” they are). The algorithm evolves the population of candidate solutions over several generations, with the aim of finding the best or a sufficiently good solution to the problem. In the present context, the variable which constrains each solution, and which is modified in each generation of the evolutionary algorithm, is/are the N-dimensional vectors 1108 to 1112.

The system 800 may instruct a plurality of agents (not shown) to implement the search process 910. For example, the system 800 may implement a plurality of the versions of the agent 810 in parallel. The plurality of agents may comprise, or be associated with, a respective plurality of neural networks (not shown), such as a neural network 812. By implementing a plurality of agents in parallel, it is possible for the system 800 to converge on solutions to the instance of the optimization problem faster. Where a plurality of agents are instructed, an initial N-dimensional vector 1108 selected by each agent may be different. By selecting different initial N-dimensional vectors 1108 to 1112, the plurality of agents will search different portions of the vector latent space 1002. Searching different portions of the vector latent space may increase the speed with which optimal, or near optimal, solutions may be found. Additionally, using a plurality of agents may prevent the search process 910 from focusing on local maxima or minima in the vector latent space.

Where the system 800 instructs a plurality of agents, and/or where the agent 810 is instructed to perform the search process multiple times using different initial N-dimensional vectors 1108 to 1112, the initial N-dimensional vectors may be selected by applying a prior distribution to the vector latent space. The characteristics of the prior distribution may be configured to select a suitable distribution of N-dimensional vectors to provide a desired variability enabling the search process 910 to search widely across the vector latent space 1002.

Additionally, or alternatively, the prior distribution may be configured based on a learned distribution from one or more previous implementations, or outcomes, of applying the method 900 to a similar instance of the optimization problem. This may provide more promising, and hence more efficient, starting N-dimensional vectors 1108 to 1112, which the search process 910 can refine. The prior distribution may be updated based on an evaluation of the solution(s) according to the reward function 1008. In this way, it is possible to further refine the starting conditions for the search process 910.

As described above, the search process 910 may be performed until a search budget is exhausted. At the end of the search process, a plurality of solutions, produced during different iterations of the search process 910, may be generated. While the performance of the system 800 is generally expected to improve over time as the N-dimensional vector z^{→} is updated, the final solution produced by the system 800 may not be the best solution generated during the search process 910. As such, the method 900 may comprise storing a plurality of solutions, each solution having been generated during a respective iteration of the search process 910. At the end of the search process 910, the plurality of solutions may be evaluated according to one or more desired characteristics, and one of the plurality of solutions may be selected and output by the system 800. Evaluating the plurality of solutions may involve using the reward function 1008 but may alternatively, or additionally, involve a different reward function that is adapted for use in evaluating which of the plurality of solutions is to be output by the system 800.

While the vector latent space 502 used during the training method 300 has not been distinguished from the vector latent space 1002 used during the inference method 900 in the above description, it is to be appreciated that these vector latent spaces may differ. For example, during training, the vector latent space 502 used may include a higher precision and/or dimensionality than the vector latent space 1002 used during inference. During training, there may be fewer hardware and/or time constraints in training the neural network 110. During inference, and particularly when implemented in portable, or low-power, systems, there may be hardware and/or time constraints. As such, while corresponding to the vector latent space 502 used during training, the vector latent space 1002 determined when performing the method 900 may have fewer possible vectors that can be selected. In this way, the search space that is processed may be smaller than that used during training.

While the examples described above refer to a vector latent space 502 or 1002 having a certain precision, wherein vectors sampled from the vector latent space 502 or 1002 are represented using values that can be processed by the neural network 110 or 812, in some examples the vector latent space 502 or 1102 is a continuous space. In other words, while the vectors sampled from the vector latent space 502 or 1102 may be discrete values, the vector latent space 502 or 1102 may not be so constrained, and hence the vectors sampled from the vector latent space 502 or 1102 may be sampled at any suitable precision. In some examples, updating the N-dimensional vector z^{→} during the search process 910 may comprise updating one or values of the vector z^{→} and/or updating the precision with which those values are represented. In this way, the method 900 is able to fine tune the solutions generated by increasing the precision of the vectors z^{→}, when searching in an area of the vector latent space 1002 that is associated with an optimal, or near optimal, solution.

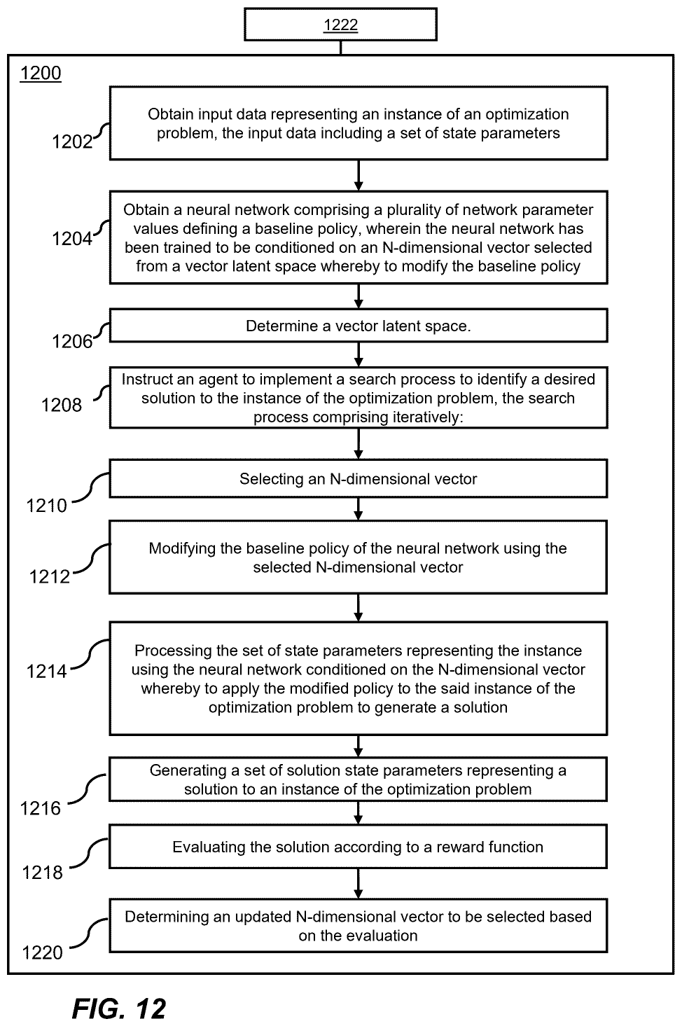

FIG. 12 shows a non-transitory computer-readable storage medium 1200 comprising computer-executable instructions 1202 to 1220 which, when executed by a processor 1222, cause the processor 1220 to perform the method 900 of using a neural network 812 to generate solutions to an instance of an optimization problem.

It is to be appreciated that any examples described above may be used alone, or in combination with any other examples described. The preceding description and accompanying figures are not intended to be exhaustive or to limit the invention to the precise form described. Variations and modifications are possible in light of the above teachings.

What is claimed is:

1. A method of training a neural network to determine solutions to an optimization problem, the method comprising:
obtaining a neural network comprising a plurality of network parameter values defining a policy, wherein the neural network is configured to obtain a state signal representing a state of an instance of the optimization problem and to process state parameters included therein according to the plurality of network parameter values to generate action selection data for selecting an action to be performed by an agent in response to the state signal;
obtaining training data representing a plurality of instances of an optimization problem, each instance of the optimization problem being represented by a set of state parameters; and
for each instance of the optimization problem in the training data:
generating a plurality of solutions for the said instance of the optimization problem, wherein each of the plurality of solutions is generated by:
conditioning the policy of the neural network according to an N-dimensional vector; and
processing a set of state parameters representing the said instance using the neural network conditioned on the N-dimensional vector whereby to apply the conditioned policy to the said instance of the optimization problem;
evaluating each of the plurality of solutions according to a reward function to identify a said N-dimensional vector associated with a highest performing solution; and
training the neural network conditioned on the said N-dimensional vector for the said instance of the optimization problem.

2. The method of claim 1, wherein the method comprises determining a vector latent space, and wherein the N-dimensional vector is selected from the vector latent space.

3. The method of claim 2, wherein determining the vector latent space comprises:
selecting a number of dimensions that are to be defined for the vector latent space; and
selecting a distribution of values for each dimension.

4. The method of claim 2, wherein determining the vector latent space comprises:
selecting a number of dimensions that are to be defined for the vector latent space; and
selecting an upper limit and a lower limit for each dimension.

5. The method of claim 3, wherein determining the vector latent space comprises selecting a precision for each dimension.

6. The method of claim 1, wherein the method comprises determining a set of N-dimensional vectors selected from the vector latent space which are to be used to generate the plurality of solutions, wherein determining the set of N-dimensional vectors involves sampling the N-dimensional vectors from the vector latent space.

7. The method of claim 6, wherein sampling the N-dimensional vectors from the vector latent space comprises applying a uniform distribution function to the vector latent space and selecting the set of N-dimensional vectors based on the distribution function.

8. The method of claim 1, wherein the neural network is pre-trained for generating solutions to the optimization problem according to a reinforcement learning training procedure.

9. The method of claim 8, wherein the method further comprises modifying the pre-trained neural network by adding a further set of parameter values, and wherein conditioning the policy involves modifying the further set of parameter values according to the respective N-dimensional vector.

10. The method of claim 1, wherein conditioning the policy for the said instance comprises concatenating the N-dimensional vector with the set of state parameters.

11. The method of claim 1, wherein the neural network is trained on the plurality of instances of the optimization problem in batches of the instances, and wherein the method comprises selecting a batch size.

12. The method of claim 1, wherein training the neural network conditioned on the N-dimensional vector for the said instance of the optimization problem comprises determining a loss for the respective solution using a loss function and training the neural network conditioned on the N-dimensional vector based on the determined loss.

13. The method of claim 12, wherein training the neural network comprises backpropagation using gradient descent.

14. The method of claim 1, wherein each of the plurality of solutions generated for a said instance of the optimization problem is associated with a different N-dimensional vector, and wherein the method comprises selecting a number of N-dimensional vectors to be used to generate the plurality of solutions.

15. A system configured to train a neural network to determine solutions to an optimization problem, the system comprising at least one processor, and computer-readable storage comprising computer-executable instructions which, when executed by the at least one processor, cause the system to:
obtain a neural network comprising a plurality of network parameter values defining a policy, wherein the neural network is configured to obtain a state signal representing a state of an instance of the optimization problem and to process state parameters included therein according to the plurality of network parameter values to generate action selection data for selecting an action to be performed by an agent in response to the state signal;
obtain training data representing a plurality of instances of an optimization problem, each instance of the optimization problem being represented by a set of state parameters; and
for each instance of the optimization problem in the training data:
generate a plurality of solutions for the said instance of the optimization problem, wherein each of the plurality of solutions is generated by:
conditioning the policy of the neural network according to an N-dimensional vector; and
processing a set of state parameters representing the said instance using the neural network conditioned on the N-dimensional vector whereby to apply the conditioned policy to the said instance of the optimization problem;
evaluate each of the plurality of solutions according to a reward function to identify a said N-dimensional vector associated with a highest performing solution; and
train the neural network conditioned on the said N-dimensional vector for the said instance of the optimization problem.

16. A computer-readable non-transitory storage medium on which is stored computer-executable instructions which, when executed by at least one processor, cause the at least one processor to:
obtain a neural network comprising a plurality of network parameter values defining a policy, wherein the neural network is configured to obtain a state signal representing a state of an instance of the optimization problem and to process state parameters included therein according to the plurality of network parameter values to generate action selection data for selecting an action to be performed by an agent in response to the state signal;
obtain training data representing a plurality of instances of an optimization problem, each instance of the optimization problem being represented by a set of state parameters; and
for each instance of the optimization problem in the training data:
generate a plurality of solutions for the said instance of the optimization problem, wherein each of the plurality of solutions is generated by:
conditioning the policy of the neural network according to an N-dimensional vector; and
processing a set of state parameters representing the said instance using the neural network conditioned on the N-dimensional vector whereby to apply the conditioned policy to the said instance of the optimization problem;
evaluate each of the plurality of solutions according to a reward function to identify a said N-dimensional vector associated with a highest performing solution; and
train the neural network conditioned on the said N-dimensional vector for the said instance of the optimization problem.

17. A method of using a neural network to generate solutions to an optimization problem, the method comprising:
obtaining input data representing an instance of an optimization problem, the input data including a set of state parameters;
obtaining a neural network comprising a plurality of network parameter values defining a policy, wherein the neural network has been trained to be conditioned on an N-dimensional vector selected from a vector latent space;
determining the vector latent space;
instructing an agent to implement a search process to identify a desired solution to the instance of the optimization problem, the search process comprising iteratively:
selecting an N-dimensional vector;
conditioning the policy of the neural network using the selected N-dimensional vector;
processing the set of state parameters representing the instance using the neural network conditioned on the N-dimensional vector whereby to apply the conditioned policy to the said instance of the optimization problem to generate a solution;
generating a set of solution state parameters representing a solution to an instance of the optimization problem;
evaluating the solution according to a reward function; and
determining an updated N-dimensional vector to be selected based on the evaluation.

18. The method of claim 17, wherein the agent is provided with a predetermined search budget, and wherein the search process is performed until the predetermined search budget is exhausted.

19. The method of claim 18, wherein the predetermined search budget includes a specified number of times the search process may be performed.

20. The method of claim 18, wherein the predetermined search budget includes a predetermined time period for which the search process may be performed.

21. The method of claim 18, wherein the predetermined search budget includes a predetermined amount of computing resources which may be used to perform the search process.

22. The method of claim 17, wherein the updated N-dimensional vector is determined in a manner which aims to select an N-dimensional vector that increases a reward obtained by the reward function.

23. The method of claim 17, wherein the search process involves applying an evolutionary algorithm to identify updated N-dimensional vectors to be selected.

24. The method of claim 17, wherein the method comprises instructing a plurality of agents to implement the search process, and wherein an initial N-dimensional vector selected by each when starting the search process is different.

25. The method of claim 24, wherein the initial N-dimensional vectors are selected by applying a prior distribution to the vector latent space.

26. The method of claim 25, wherein the search process comprises updating the prior distribution based on the evaluation of the solution according to the reward function.

27. A system configured to implement a neural network to determine solutions to an optimization problem, the system comprising at least one processor, and computer-readable storage comprising computer-executable instructions which, when executed by the at least one processor, cause the system to:
obtain input data representing an instance of an optimization problem, the input data including a set of state parameters;
obtain a neural network comprising a plurality of network parameter values defining a policy, wherein the neural network has been trained to be conditioned on an N-dimensional vector selected from a vector latent space w;
determine the vector latent space;
instruct an agent to implement a search process to identify a desired solution to the instance of the optimization problem, the search process comprising iteratively:
selecting an N-dimensional vector;
conditioning the policy of the neural network using the selected N-dimensional vector;
processing the set of state parameters representing the instance using the neural network conditioned on the N-dimensional vector whereby to apply the conditioned policy to the said instance of the optimization problem to generate a solution;
generating a set of solution state parameters representing a solution to an instance of the optimization problem;
evaluating the solution according to a reward function; and
determining an updated N-dimensional vector to be selected based on the evaluation.

28. A computer-readable non-transitory storage medium on which is stored computer-executable instructions which, when executed by at least one processor, cause the at least one processor to:
obtain input data representing an instance of an optimization problem, the input data including a set of state parameters;
obtain a neural network comprising a plurality of network parameter values defining a policy, wherein the neural network has been trained to be conditioned on an N-dimensional vector selected from a vector latent space w;
determine the vector latent space;
instruct an agent to implement a search process to identify a desired solution to the instance of the optimization problem, the search process comprising iteratively:
selecting an N-dimensional vector;
conditioning the policy of the neural network using the selected N-dimensional vector;
processing the set of state parameters representing the instance using the neural network conditioned on the N-dimensional vector whereby to apply the conditioned policy to the said instance of the optimization problem to generate a solution;
generating a set of solution state parameters representing a solution to an instance of the optimization problem;
evaluating the solution according to a reward function; and
determining an updated N-dimensional vector to be selected based on the evaluation.
